(19) United States
(12) Patent Application Publication
(10) Pub. No.: US 2019/0291700 A1
(43) Pub. Date: Sep. 26, 2019

(54) Wheel Cleaning Tool

(71) Applicant: Brokenman Inc., Danbury, CT (US)

(72) Inventor: Larry Kosilla, III, Danbury, CT (US)

(21) Appl. No.: 16/280,773

(22) Filed: Feb. 20, 2019

Related U.S. Application Data
(60) Provisional application No. 62/645,419, filed on Mar. 20, 2018.

(51) Int. Cl. B60S 3/04; B08B 1/04; B08B 1/00

(52) U.S. Cl. CPC B60S 3/042; B08B 1/002; B08B 1/04

(57) ABSTRACT

A cleaning tool and a system for cleaning an automotive component include the cleaning tool with a portable dispenser configured to receive a both a cleanser and a pressurized gas in a hollow interior section and a flexible conduit interconnecting the portable dispenser with a brush. The brush has a hollow handle with apertures and a porous cleaning portion. The cleanser is a humectant foaming cleanser. A cleanser removing tool is effective to remove dirt, brake dust and grease from the automotive component without a water rinse.

### CROSS-REFERENCE TO RELATED APPLICATIONS

This patent application claims a benefit to the filing date of U.S. provisional patent application Ser. No. 62/645,419 that was filed on Mar. 20, 2018. The disclosure of U.S. 62/645,419 is incorporated by reference herein in its entirety.

### BACKGROUND OF THE DISCLOSURE

An individual seeking to wash the wheels of an automobile typically utilizes brushes, wheel cleaning tools and wash mitts in cooperation with a bucket of water, soap and a hose to rinse off the suds. The individual first dunks the tool into the wash bucket and then quickly cleans the front and rear of the wheel spokes, re-dunks the tool, cleans and repeats as often as necessary. In short order, the tool and the water become contaminated after an initial wipe as the tool is dunked in water, reused and re-dunked to clean the wheel. Copious amounts of water and soap are required.

A first problem with the traditional method of washing the wheels of an automobile is the large number of items required, including buckets, soap, cloths, mitts and bucket inserts, typically referred to as grit-guards, which are specifically designed to help control the brake dust or contamination problem within the bucket. A second, and growing, problem is cross-contamination between sharp and jagged brake dust particles and the finish on the wheel. Although rinsing the tools in soapy water is helpful, the water becomes increasingly dirty with each subsequent dunk in the bucket. This build-up of sharp contamination creates scratches in the wheel finish called “micro-marring” and, over time, will deteriorate the wheel finish. The sharp or jagged pieces of metal fillings is commonly referred to as “brake dust,” which are emitted from brake pads during the act of stopping a vehicle. As wheels have become more expensive and intricate, the brake dust micro-marring is becoming a concern for car collectors because polishing or restoring these scratches is extremely difficult due to the tight and complex angles of the spoke that do not allow easy access for polishing pad restoration. However, the wheel brush system described below will avoid contamination altogether by constantly introducing fresh cleaning solution through the brush head without a need for dunking and re-dunking into an increasingly contaminated bucket.

Yet a third problem is that many communities restrict water usage during period of drought. Communities also regulate run-off to prevent ground water and stream contamination. Some communities go so far as to prohibit washing an automobile in a private driveway during certain seasons.

Individuals also wash their automobiles at automated car washes. These car washes sometimes include a do-it-yourself bay that utilizes a big brush attached to a wall that shoots out foam to scrub the automobile with conventional soap. Afterwards, the individual rinses the soapy paint and then dries the car completely. Copious amounts of water are required to completely rinse and remove the soap suds. This may be problematic where water use is restricted and waste-water flow regulated. Likewise, do-it-yourself carwashes are synonymous with contaminated brushes and severe scratching due to the high volume of traffic and varying levels of extreme dirt each previous patron may have had on their car prior to using the wash bay. This is not a safe option to properly maintain expensive wheels or paint.

There is a need for a system to clean the wheels of an automobile that does not require water from a hose, eliminates cross-contamination and is portable.

### BRIEF SUMMARY OF THE DISCLOSURE

In a first embodiment, there is disclosed a cleaning tool having a portable dispenser configured to receive a cleanser, a flexible conduit interconnecting the portable dispenser with a brush. The brush has a hollow handle with apertures and a porous cleaning portion.

In a second embodiment, there is disclosed a system for cleaning an automotive component. This system includes a cleaning tool having a portable dispenser configured to receive both a cleanser and a pressurized gas in a hollow interior section and a flexible conduit interconnecting the portable dispenser with a brush. The brush has a hollow handle with apertures and a porous cleaning portion. The cleanser is a humectant foaming cleanser. A cleanser removing tool is effective to remove dirt, brake dust and grease from the automotive component without a water rinse.

A benefit of the system disclosed herein is that cleaning system does not require access to running water, buckets or wash mitts. This may be useful when water is not accessible or in winter when hoses may be stored to prevent freezing and cracking.

Other benefits include the system is self-contained and portable and may be left in the trunk of an automobile or bed of a truck. The humectant foaming cleanser evaporates quickly. An exemplary time from deposition to evaporation is three minutes. Following evaporation, no water remains on the surface on the wheel being cleaned. The use of self-contained compressed air to move the foam through a hose and through a wheel cleaning tool provides a constant fresh cleaning product thereby avoiding dirty-water dipping and scrubbing scratches.

### BRIEF DESCRIPTION OF THE DRAWINGS

FIG. 1 is a view, partially in cross-section, of the wheel cleaning tool described herein.

FIG. 2 is a cross-sectional view of a brush for use with the wheel cleaning tool of FIG. 1.

FIG. 3 is a cross sectional view of a pressurized dispenser for use with the wheel cleaning tool of FIG. 1.

### DETAILED DESCRIPTION

The disclosure presents a solution to micro-marring (i.e. scratching) by continuously introducing new, fresh, uncontaminated cleaning fluid directly to the source of the dirt/grease on the wheel and wheel components, such as the caliper and backside of the wheel. Cross-contamination is eliminated because the brush does not get dunked and re-dunked in a dirty water bucket. The wheel cleaning tool minimizes a need for water and reduces water-runoff. As described below, the wheel cleaning tool utilizes a foam solution that does not require water to rinse away the cleansing soap. This type of solution is referred to as “hoseless” and is also referred to as a waterless wash. The hoseless wash is pushed through a hose and into the wheel cleaning tool by a portable pressurized device.

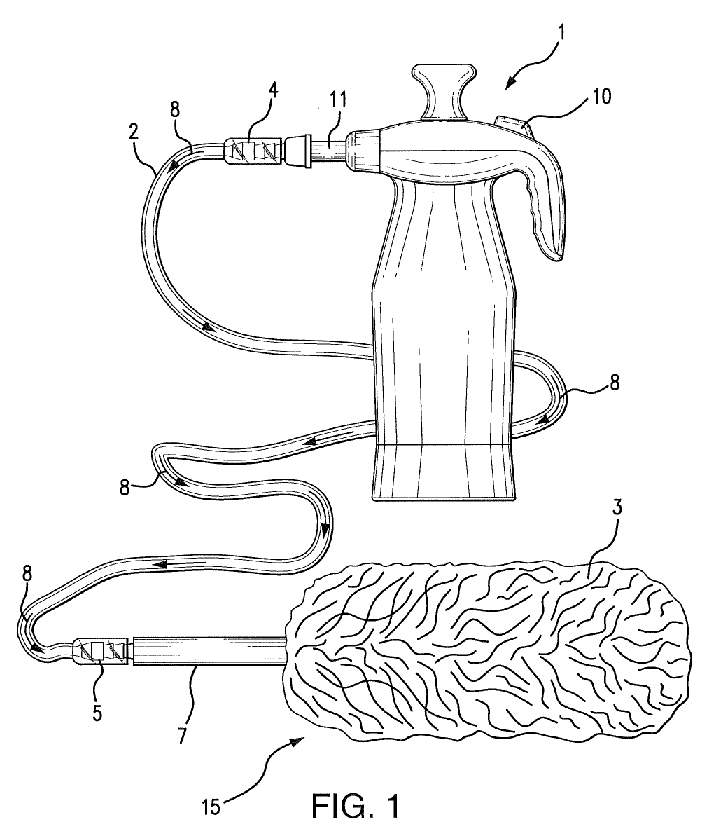

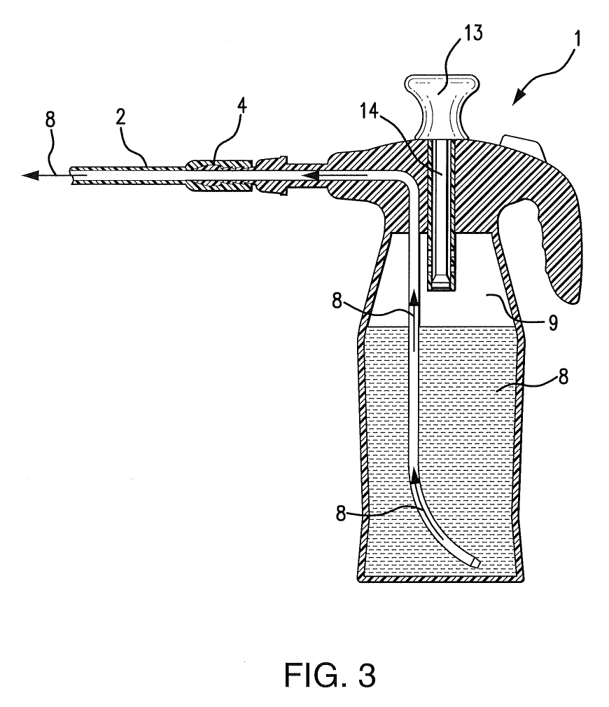

FIG. 1 is a view, partially in cross-section, of a wheel cleaning tool as described herein. The tool includes a portable dispenser 1 that, as shown in FIG. 3 has a hollow interior section configured to receive both a gas under pressure 9 and a humectant foaming cleanser 8.

By portable, it is meant that the dispenser 1 may be easily carrier by the typical driver of an automobile or truck. An exemplary dispenser has a weight of between 0.6 pound and 0.8 pound when empty and a weight of between 3 pounds and 3.3 pounds when fully charged with the gas under pressure 9 and the humectant foaming cleanser 8.

A humectant is a substance that retains moisture, such that a humectant foaming cleanser contains moisture and/or lubricants in the foam and does not require an external source of moisture, such as hose. The moisture content is selected so that there is ample time to disperse the foam during cleaning, exemplary is from 1-5 minutes with 3 minutes being an exemplary target, before the moisture evaporates. The rate of evaporation is dependent on the cleaning environment. Evaporation will be much quicker in a hot desert than a cold prairie. However, the compositions detailed below are equally effective in different environments because while a nominal composition may have a ratio, as measured at ambient temperature, by volume, of 20 ounces of water to 1 ounce of humectant foaming cleanser, that ratio may be varied. Before the moisture evaporates, the contaminants suspended in the foam are safely removed from the surface of the wheel with a removal tool, such as a microfiber towel. No rinsing or additional water is required for the removal step due to the quick rate of evaporation.

Exemplary humectant foaming cleansers have a non-aqueous liquid as a primary moisture contributor, such as lanolin or glycol. Also included may be detergents, lubricants, solvents and a foaming agent.

Referring back to FIG. 1, the dispenser 1 includes a thumb-actuated trigger 10 that when depressed enables the humectant foaming 8 cleanser to exit via nozzle 11. A flexible tube 2 provides a conduit between the dispenser 1 and a cleaning brush 15. First connector 4 and second connector 5 provide a leak proof seal to the dispenser 1 and a hollow handle 7 of the cleaning brush 15. The cleaning brush 15 includes a porous cleaning portion 3 affixed to the hollow handle 7 at an end opposite the second connector 5. The flexible tube 2 is selected to be non-reactive with the humectant foaming cleanser 8 and resistant to damage from physical abuse or temperature extremes. An exemplary material for the flexible tube 2 is braided nylon, typical to that used in refrigerator water lines. Exemplary dimensions for the flexible tube are and outside diameter of 0.325 inch and an inner bore with an exemplary bore of 0.25 inch.

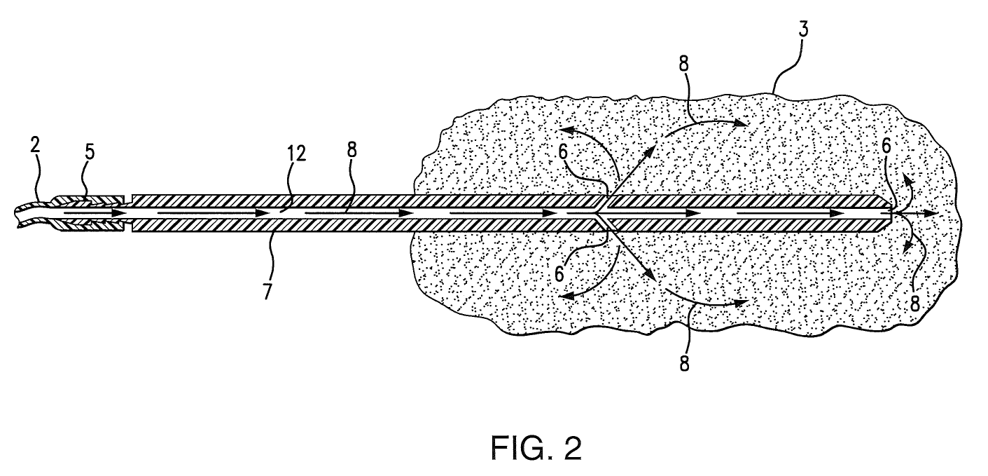

As shown in FIG. 2, second connector 5 joins the flexible tube 2 to a rear portion of the hollow handle 7. An internal bore 12 delivers humectant foaming cleanser 8 to a forward portion of the hollow handle where a plurality of apertures 6 disperse the humectant foaming cleanser into the porous cleaning portion 3.

The porous cleaning portion 3 is formed from a porous material formed from a multitude of fibers bunched together, such as a big cotton ball. Exemplary fibers are formed from polypropylene and have a nominal diameter of between 10 and 50 micrometers. The thickness of the brush, in a direction transverse to the axis of the hollow handle is about 3.5 inches and the length of the brush along the axis of the hollow handle is about 7 inches.

FIG. 3 illustrates components of the dispenser 1 showing rod cap 13 and rod 14 that go up and down while pumping or compressing air into the tank, referred to as stroke displacement. An exemplary charge for the dispenser 1 is 1 ounce of humectant foaming cleanser 8 and a charge of air 9 under a pressure of up to 35 pounds per square inch with pressure and volume measured at a nominal room temperature of 72° F.

While described in terms of a wheel cleaning tool, the cleaning tool described herein is not limited to wheels and may be utilized for cleaning any surface.

I claim:

1. A cleaning tool, comprising:
a portable dispenser configured to receive a cleanser;
a flexible conduit interconnecting the portable dispenser with a brush; and
the brush having a hollow handle with apertures and a porous cleaning portion.

2. The cleaning tool of claim 1 wherein the portable dispenser has a hollow interior section effective to receive a gas under pressure.

3. The cleaning tool of claim 2 wherein the hollow interior section is further effective to receive a humectant foaming cleanser.

4. The cleaning tool of claim 3 wherein the humectant foaming cleanser has a non-aqueous liquid as a primary moisture contributor.

5. The cleaning tool of claim 4 wherein the non-aqueous liquid is selected from the group consisting of lanolin and glycol.

6. The cleaning tool of claim 4 wherein the porous cleaning portion is a multitude of fibers bunched together.

7. The cleaning tool of claim 6 wherein the multitude of fibers are formed from polypropylene.

8. The cleaning tool of claim 7 wherein the multitude of fibers have a diameter between 10 micrometers and 50 micrometers.

9. The cleaning tool of claim 8 wherein the non-aqueous liquid is selected from the group consisting of lanolin and glycol.

10. The cleaning tool of claim 9 wherein the gas under pressure is 35 pounds per square inch.

11. A system for cleaning an automotive component, comprising:
a cleaning tool having a portable dispenser configured to receive a both a cleanser and a pressurized gas in a hollow interior section, a flexible conduit interconnecting the portable dispenser with a brush, the brush having a hollow handle with apertures and a porous cleaning portion;
the cleanser being a humectant foaming cleanser; and
a cleanser removing tool effective to remove dried cleanser from the automotive component without a water rinse.

12. The system of claim 11 wherein the humectant foaming cleanser is mixed with water in the cleaning tool.

13. The system of claim 12 wherein the porous cleaning portion is a multitude of fibers bunched together.

14. The system of claim 13 wherein the multitude of fibers are formed from polypropylene.

15. The system of claim 14 wherein the multitude of fibers have a diameter between 10 micrometers and 50 micrometers.

16. The system of claim 15 wherein the gas under pressure is 35 psi.

17. The system of claim 16 wherein the automotive component is a wheel.

18. The system of claim 16 wherein the ratio of humectant foaming cleanser to water is variable dependent on the cleaning environment.

19. The system of claim 18 wherein the ratio of humectant foaming cleanser to water is variable is, by volume, 20:1.
